(19) United States
(12) Patent Application Publication
(10) Pub. No.: US 2007/0062101 A1
(43) Pub. Date: Mar. 22, 2007

(54) Stable emulsions which are used to lower the pour point of crude oils and to inhibit paraffin deposition

(76) Inventors: Marie-France Delamotte, Saint Foy Les Lyon (FR); Didier Faure, Feyzin (FR); Denis Tembou N'Zudie, Irigny (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/569,672

(22) PCT Filed: Aug. 5, 2004
(86) PCT No.: PCT/FR04/02092

§ 371 Date: Oct. 6, 2006

(30) Foreign Application Priority Data
Aug. 28, 2003 (FR) 0310242

(51) Int. Cl. C10L 1/18; C09D 5/02

(52) U.S. Cl. 44/389; 524/501; 44/337; 524/504

(57) ABSTRACT

The present invention relates to compositions based on olefinic copolymers and/or polyacrylates in the form of stable and concentrated emulsions. Such compositions are particularly effective as additives for lowering the pour point of crude oils and/or for inhibiting paraffin deposition in crude oils, especially in one-pot form.

### TECHNICAL FIELD

The present invention relates to compositions of polymers that are “incompatible in organic solution”, i.e. which separate into several distinct phases when the polymer solutions are mixed together and left to stand. The compositions according to the invention, which are in the form of stable emulsions, provide a solution to this problem of phase separation that gives rise to implementation difficulties during the use of the combination of said polymers on oil fields.

Many crude petroleum oils contain large fractions of paraffins, the amount and exact nature of which are variable according to the fields from which they are extracted. At the well temperature, paraffins are liquid and dissolved in the crude oil. During the raising of the oil to the surface, its temperature lowers and the paraffins, on crystallizing, form a three-dimensional network of needles and flakes. This results in a loss of fluidity that makes the production, transportation, storage and even the processing of these oils very difficult. Blocking of pipelines and of processing equipment is frequent.

### PRIOR ART

Many processes have been proposed to solve this problem, for instance mechanical scraping or heating of the walls. These processes are expensive and are not always implementable. To improve the rheology of crude oils, various families of polymers have been proposed:

i) ethylene copolymers, for instance copolymers of ethylene and of vinyl acetate (EVA) described in FR 2 184 522 (1972); RU 785 337 describes products of copolymerization between ethylene, vinyl acetate and maleic anhydride; U.S. Pat. No. 3,341,309 and U.S. Pat. No. 3,304,261 from Esso recommend the use of products of copolymerization of ethylene, vinyl acetate and dilauryl or diisodecyl fumarate; U.S. Pat. No. 4,160,459 from Texaco describes products of copolymerization between ethylene, vinyl acetate and alkyl methacrylates;

ii) ethylene copolymers grafted with polymers such as poly(n-alkyl (meth)acrylates). U.S. Pat. No. 4,608,411 from Elf describes copolymers of this type, typical examples of which are EVA grafted with poly(n-alkyl acrylate) chains;

iii) (co)polymers of one or more n-alkyl (meth)acrylate monomers, with n ranging from 6 to 40, optionally with one or more comonomers such as vinylpyridines, fatty-chain α-olefin monomers (n-alkyl, with n ranging from 6 to 40) and monomers chosen from ethylenically unsaturated monocarboxylic and/or dicarboxylic acids or anhydrides: see, for example, U.S. Pat. No. 6,218,490 from CECA, U.S. Pat. No. 4,663,491 from Stauchausen, and U.S. Pat. No. 2,839,512 and FR 2 128 589 from Shell.

These polymers i) to iii) described above are generally proposed in organic solution form for processing crude petroleum oils. However, polymers derived from the families i) or iii) in emulsion or dispersion form have been the subject of patents: polymers iii) in emulsion are described in WO 03/014170 from Ceca, U.S. Pat. No. 4,110,283 from Servo, EP 448 166 and WO 98/51731 from Shell and WO 98/33846 from British Petroleum; polymers i) in emulsion form have been recommended in CA986635 from Exxon and EP 46 190 from BASF.

As regards improving the properties of crude oils by adding these polymers, the families of polymers i), ii) and iii) in solution have often shown limits in terms of efficacy for certain crudes when they are used individually, whereas the combination of the various families allows efficacy synergism to be released. Thus, a combination between EVA and long-alkyl-chain polyacrylates [polymer i)+polymer iii)] has shown an improvement in performance compared with each polymer taken separately. Such combinations are described in GB 1 112 803 from Esso and U.S. Pat. No. 4,153,423 from Exxon. However, the polymer blends in solution derived from the combination of families i), ii) and iii) have shown stability limits associated with their “incompatibility”. A person skilled in the art must thus address this problem of “incompatibility” of the polymers and of stability of their organic solutions, i.e. of polymers that separate into several distinct phases when the organic solutions are mixed together and left to stand. As a result, it is impossible to market a stable solution comprising a blend of these polymers. Petroleum additive manufacturers must consequently propose each family of polymers [i), ii), or iii)] separately, leaving it to the discretion of the petroleum operators to manage the implementation of their combination on the oil fields at the time of injection into the crude oil. It is well known in the art of petroleum production that this problem can be addressed by using:

either a stirred tank containing the solution of blend of said polymers before injection into the crude oil. The stirring, which must be maintained permanently, thus makes it possible to avoid separation of the phases before injection;

or several injection lines, each line being dedicated to one family of polymers.

In these two cases, the petroleum operator is led to address an investment in equipment and also constraints in terms of management of several products, which increase the production difficulties, but also the cost of the extraction.

### DESCRIPTION OF THE INVENTION

The polymer compositions according to the invention comprise polymers derived from at least two of the three families:
i) copolymers of ethylene and of at least one ethylenically unsaturated monomer, for example vinyl acetate (EVA),
ii) ethylene copolymers as defined in i) grafted with polymers such as fatty-chain polyacrylates (e.g. EVA grafted with poly(n-alkyl acrylate)), and
iii) (co)polymers of n-alkyl (meth)acrylate and of monomers chosen from the following group: fatty-chain α-olefins (n-alkyl, with n ranging from 6 to 40), vinyl esters, vinylaromatics, vinylpyridines and derivatives thereof, N-vinylpyrrolidone, (meth)acrylamides and derivatives thereof, ethylenically unsaturated monocarboxylic and/or dicarboxylic acids or anhydrides or ethylenically unsaturated monocarboxylic and/or dicarboxylic anhydrides
and are in the form of a stable emulsion.

The compositions of the present invention preferably comprise at least 100 parts by weight of constituents 1 to 6 below:

1) 5 to 70, preferably 5 to 50 and advantageously 5 to 40 parts by weight of at least two (co)polymers belonging to at least two of the families i) ii) and iii) below:

i) ethylene copolymers containing 50% to 90% and advantageously 60% to 80% by weight of ethylene and 10% to 50% and advantageously 20% to 40% by weight of at least one ethylenically unsaturated monomer chosen from the following group: C₂ to C₁₈ and advantageously C₂ to C₅ vinyl esters, monocarboxylic acids, C₁ to C₁₂ alkyl esters of C₃ to C₁₂ monocarboxylic acids, unsaturated α,β-dicarboxylic compounds in diacid, C₁ to C₁₂ alkyl diester or anhydride form. Among the vinyl esters, vinyl acetate is advantageously used. Among the unsaturated monocarboxylic acid esters, C₁ to C₁₂ and advantageously C₁ to C₅ acrylates and methacrylates are preferably used. The unsaturated α,β-dicarboxylic compounds are preferentially the methyl, ethyl or propyl diesters of maleic acid, alkylmaleic acid, fumaric acid or alkylfumaric acid;

ii) copolymers of ethylene described in i) grafted with polymers that are (co)polymers derived from 50% to 100% and preferably from 70% to 100% by weight of one or more n-alkyl (meth)acrylate monomers, with n ranging from 6 to 40 and preferably from 14 to 30, and optionally 0 to 50% and preferably from 0 to 30% of one or more monomers chosen from the following group: fatty-chain α-olefins (n-alkyl, with n ranging from 6 to 40), vinyl esters, vinylaromatics, vinylpyridines and derivatives thereof, N-vinylpyrrolidone, (meth)acrylamides and derivatives thereof, ethylenically unsaturated monocarboxylic and/or dicarboxylic acids or anhydrides or ethylenically unsaturated monocarboxylic and/or dicarboxylic anhydrides; the grafted copolymers ii) comprise 5% to 95% and advantageously 40% to 75% by weight of ethylene copolymer i) forming the trunk;

iii) (co)polymers derived from 50% to 100% and preferably from 70% to 100% by weight by one or more n-alkyl (meth)acrylate monomers, with n ranging from 6 to 40 and preferably from 14 to 30, and optionally 0 to 50% and preferably from 0 to 30% of one or more monomers chosen from the following group: fatty-chain α-olefins (n-alkyl, with n ranging from 6 to 40), vinyl esters, vinylaromatics, vinylpyridines and derivatives thereof, N-vinylpyrrolidone, (meth)acrylamides and derivatives thereof, ethylenically unsaturated monocarboxylic and/or dicarboxylic acids or anhydrides or ethylenically unsaturated monocarboxylic and/or dicarboxylic anhydrides;

2) 0 to 60 parts by weight of a water-immiscible solvent or mixture of solvents, preferably chosen from aromatic solvents (toluene or xylene), alone or as a mixture;

3) 0 to 30 parts by weight, preferably from 5 to 25 and advantageously from 5 to 20 parts by weight of a water-miscible cosolvent or mixture of cosolvents chosen from ketones such as methyl ethyl ketone or methyl isobutyl ketone, alcohols such as butanol or isopropanol, glycols and polyglycol ethers such as ethylene or propylene glycol, diethylene glycol or dipropylene glycol;

4) 0.1 to 10, preferably from 0.1 to 8 and advantageously from 0.5 to 5 parts by weight of one or more surfactants (ionic (cationic or anionic) and/or nonionic surfactants) and/or protective colloids and/or amphiphilic polymers; among the cationic surfactants, mention may be made of quaternary ammonium salts such as dimethyldialkylammonium chlorides and protonated fatty amines; among the nonionic surfactants, mention may be made of polyethoxylated fatty alcohols, polyethoxylated fatty acids and polyethoxylated alkyl phenols; among the anionic surfactants, mention may be made of sulfated polyethoxylated fatty alcohols, sulfated polyethoxylated fatty acids, sulfated polyethoxylated alkyl phenols, alkylbenzene sulfonates and sulfosuccinates, and neutralized fatty acids; among the protective colloids, mention may be made of polyvinyl alcohols; among the amphiphilic polymers, mention may be made of (meth)acrylic acid copolymers, maleic anhydride copolymers neutralized with a base or imidized followed by protonation or quaternization; in the case of compositions prepared by mixing at least two emulsions (process B), it should be avoided to mix emulsions stabilized with oppositely charged surfactants, in order to avoid flocculation of the particles. Beyond this restriction, the surfactants used for the emulsions to be mixed together may be identical or different;

5) 0 to 2, preferably from 0.01 to 0.6 and advantageously from 0.02 to 0.2 part by weight of one or more thickeners, for instance Xanthane®,

6) water (qs. 100: the sum of the constituents 1) to 6) representing 100 parts by weight).

The invention also relates to processes for preparing these compositions that may be obtained according to one of the following two processes:

by emulsification of the blend of polymers derived from at least two of the families i), ii) and iii) (process A) or

by mixing emulsions of polymers of different families i), ii) and iii) (process B).

Process A of emulsification of a blend of polymers derived from at least two of the three families of polymers i), ii) and iii) mentioned above is characterized in that:

A1—a solution of polymers of at least two of the families i) to iii) described above in at least one water-immiscible organic solvent or mixture of solvents is prepared,

A2—one or more surfactants, pure or diluted in water or in another solvent (miscible or immiscible with water), is added to the solution obtained,

A3—water is added to form an emulsion,

A4—a water-miscible solvent or mixture of solvents is optionally added,

A5—one or more surfactants, which may be identical to or different than those of step A2, and/or one or more thickeners to improve the stability of the emulsion are optionally added.

Phases A1, A2, and A3 are performed with stirring at temperatures generally of at least 25° C. The temperature is chosen such that the viscosity of the solutions of the polymers to be emulsified allows scraping, blending and shearing by stirring of the mixture using a stirring spindle. Typically, the viscosity generally does not exceed 300 Pa·s (300 000 cp). Phase A4 may be performed at the same time as phase A3 or before phase A3. Phase A5 may be performed at the same time as phase A4, or before or after phase A4. The addition of water may be performed in either continuous, batch, semicontinuous or semibatch mode.

Preferably, the amounts of the reagents used are as follows:

A1—a solution of 10 to 70 parts by weight of polymers of at least two of the families i) to iii) described above in 10 to 60 parts by weight of at least one water-immiscible organic solvent or mixture of solvents is prepared,

A2—0.1 to 10 parts by weight of pure or diluted surfactant(s) are added to the solution obtained,

A3—10 to 80 parts by weight of water are added to form an emulsion,

A4—0 to 30 parts by weight of a water-miscible solvent or mixture of solvents are added,

A5—0 to 3 parts by weight of one or more surfactants and/or 0 to 2 parts by weight of one or more thickeners are added to improve the stability of the emulsion.

A variant of process A may be performed as follows:

Aa1—a solution of polymers of at least two of the families i) to iii) described above in at least one water-immiscible organic solvent or mixture of solvents is prepared,

Aa2—one or more surfactants, pure or diluted in water or in another solvent (miscible or immiscible with water), are placed in the water,

Aa3—the polymer solution prepared in Aa1) is added to the water containing the surfactant(s) prepared in Aa2) to form an emulsion,

Aa4—a water-miscible solvent or mixture of solvents is optionally added,

Aa5—one or more surfactants, which may be identical to or different than those of step Aa2, and/or one or more thickeners are optionally added to improve the stability of the emulsion.

Phases Aa1, Aa2, and Aa3 are performed with stirring at temperatures generally of at least 25° C. The temperature is chosen such that the viscosity of the solution of polymers to be emulsified allows it to be poured and to disperse in the water containing the surfactant(s) prepared in Aa2. Typically, the viscosity of the polymer solution does not generally exceed 150 Pa·s (150 000 cp). Phase A4 may be performed before phase Aa3. Phase Aa5 may be performed at the same time as phase Aa4, or before or after phase Aa4. The addition of the polymer solution may be performed in either continuous, batch, semicontinuous or semibatch mode.

Preferably, the amounts of the reagents used are in the same ranges as for process A:

Aa1—a solution of 10 to 70 parts by weight of polymers of at least two of the families i) to iii) described above in 10 to 60 parts by weight of at least one water-immiscible organic solvent or mixture of solvents is prepared,

Aa2 0.1 to 10 parts by weight of surfactant(s), pure or diluted in water or in another solvent (miscible or immiscible with water), are placed in 10 to 80 parts by weight of water,

Aa3—the polymer solution prepared in Aa1) is added to the water containing the surfactant(s) prepared in Aa2) to form an emulsion,

Aa4—0 to 30 parts by weight of a water-miscible solvent or mixture of solvents are added,

Aa5—0 to 3 parts by weight of one or more surfactants and/or 0 to 2 parts by weight of one or more thickeners are added.

Process B of emulsion mixing is characterized in that:

B1—at least two emulsions of polymers belonging solely to at least two of the three families i), ii) or iii) described above (each emulsion obtained thus contains solely polymers belonging to only one family i), ii), or iii)) are prepared according to process A above, its variant Aa or, for the polymer emulsion derived from family iii), the process may also be performed by radical emulsion polymerization, performed conventionally in apparatus known for emulsion polymerizations according to a batch, semibatch, continuous or semicontinuous process. It is also possible to prepare the emulsions of polymers i) not containing any water-immiscible solvent according to the well-known process of emulsification using an extruder,

B2—the polymer emulsions obtained in B1) are mixed together (by addition with stirring of one emulsion into the other at a temperature generally of at least 10° C., the temperature being chosen such that it is higher than the freezing point of the emulsions), it being understood that said emulsions to be mixed together must be derived from at least two of the families i), ii) and iii),

B3—one or more surfactants, which may be identical to or different than those of steps A2 or Aa2, and/or one or more thickeners are optionally added to improve the stability of the emulsion.

The organic solvents of each of the emulsions to be mixed together may be identical or different.

In the case of compositions according to the invention comprising polymers from families i) and ii), the process of emulsification of the blend of polymers i) and ii) (process A) is preferred in order to avoid double emulsification followed by mixing.

The present invention also relates to the use of the compositions according to the invention as additives for lowering the pour point of crude oils and/or for inhibiting paraffin deposition in crude oils.

The advantage of the compositions according to the invention lies in their excellent stability, which is reflected by easy implementation on oil fields. Specifically, the presence of polymers derived from at least two of the three families i) to iii) in the same composition or in one pot without them separating into several distinct phases makes it possible to avoid the use of several injection lines of different additives on oil fields and/or to provide only one tank for mixing several additives before injection into the crude oil.

For petroleum operators, the invention proposes additives that allow them to avoid multi-point injections, tank stirring before injection and the constraints in terms of management of several “incompatible” products.

The performance qualities of the compositions of Examples 1 to 3 were evaluated by measuring their pour point according to ASTM standard D97, which consists in adding the crude oil, brought to a temperature above its pour point, with a defined amount of additive, and then cooling the crude in increments of 3° C., the pour point representing the temperature at and below which the crude oil no longer pours.

In the examples below, a Herzog MP852 machine was used, the pour detection of which is effected by means of an LCD camera. All the compositions were tested in an Egyptian crude oil whose pour point measured according to this method is 33° C.

### EXAMPLE 1

In a half-liter jacketed reactor equipped with a stirrer, a reflux condenser and a bath thermostatically maintained at 75° C.:

1—75 g of a solution comprising 55% by weight of copolymer of C₁₈₋₂₂ alkyl acrylate and of 4-vinylpyridine (5% by weight of 4-vinylpyridine) in a mixture of aromatic solvents (Solvesso 150) are introduced,

2—75 g of a solution comprising 49% of copolymer of ethylene and of vinyl acetate (28% vinyl acetate) grafted with a poly(C₁₈₋₂₂ alkyl acrylate) (the grafted polyalkyl acrylate/ethylene-vinyl acetate copolymer ratio being 1) in a mixture of aromatic solvents (Solvesso 150) are added,

3—the mixture is heated to 75° C.,

4—20 g of nonionic surfactant (Remcopal 25 sold by CECA, which is an ethoxylated fatty alcohol) are introduced,

5—the reaction mixture is allowed 30 minutes to homogenize,

6—23.1 g of water are introduced over 2 hours.

7—the reactor is cooled to 30° C. and emptied.

An emulsion containing 40% of polymer and showing good stability, i.e. it does not separate into several phases at 28° C. and 50° C. after one week, is thus obtained.

### EXAMPLE 2 (COMPARATIVE)

In a half-liter jacketed reactor equipped with a stirrer, a reflux condenser and a bath thermostatically maintained at 75° C.:
1—75 g of a solution comprising 55% by weight of copolymer of C₁₈₋₂₂ alkyl acrylate and of 4-vinylpyridine (5% by weight of 4-vinylpyridine) in a mixture of aromatic solvents (Solvesso 150) are introduced,
2—75 g of a solution comprising 49% of copolymer of ethylene and of vinyl acetate (28% vinyl acetate) grafted with a poly(C₁₈₋₂₂ alkyl acrylate) (the grafted polyalkyl acrylate/ethylene-vinyl acetate copolymer ratio being 1) in a mixture of aromatic solvents (Solvesso 150) are added,
3—the mixture is heated to 75° C.,
4—53.1 g of aromatic solvent (Solvesso 150) are introduced,
5—the reaction mixture is allowed 30 minutes to homogenize,
6—the reactor is cooled to 30° C. and emptied.

The solution is obtained is not stable: when left to stand at 28° C. or at 50° C., it separates after 4 hours into two distinct phases, making it impossible to market the mixture or to use it in a single pot for addition to petroleum fluids.

### EXAMPLE 3

The compositions obtained in examples 1 and 2 are injected in a proportion of 1000 ppm into an Egyptian crude oil with a pour point of 33° C.

As regards the polymer solution of example 2, it is necessary to stir it to achieve homogenization before the addition to oil, or to separately prepare two solutions containing each of the polymers and to perform a double injection.

The crude oils containing the additives have a pour point of 9° C. It is noted that the emulsion of example 1 according to the invention has the advantages of being able to be injected into the oil without prior homogenization or double injection.

1. A polymer composition comprising polymers derived from at least two of the following three families:
i) copolyiners of ethylene and of at least one ethylenically unsaturated monomer, for example vinyl acetate (EVA),
ii) ethylene copolymers as defined in i) grafted with polymers, which are (co)polymers derived from one or more n-alkyl (meth)acrylate monomers, with n ranging from 6 to 40, and optionally from one or more monomers chosen from fatty-chain α-olefins (n-alkyl, with n ranging from 6 to 40), vinyl esters, vinylaromatics, vinylpyridines and derivatives thereof, N-vinylpyrrolidone, (meth)acrylamides and derivatives thereof, ethylenically unsaturated monocarboxylic and/or dicarboxylic acids or anhydrides or ethylenically unsaturated monocarboxylic and/or dicarboxylic anhydrides; and
iii) (co)polymers of n-alkyl (meth)acrylate and of monomers chosen from the following group: fatty-chain α-olefins (n-alkyl, with n ranging from 6 to 40), vinyl esters, vinylaromatics, vinylpyridines and derivatives thereof, N-vinylpyrrolidone, (meth)acrylamides and derivatives thereof, ethylenically unsaturated monocarboxylic and/or dicarboxylic acids or anhydrides or ethylenically unsaturated monocarboxylic and/or dicarboxylic anhydrides,
wherein they are in the form of a stable emulsion.

2. The composition as claimed in claim 1, wherein the ethylenically unsaturated monomer is chosen from C₂ to C₁₈ vinyl esters, monocarboxylic acids, C₁ to C₁₂ alkyl esters of C₃ to C₁₂ inonocarboxylic acids, unsaturated α,β-dicarboxylic compounds in diacid, C₁ to C₁₂, alkyl diester or anhydride form.

3. The composition as claimed in claim 1, comprising at least 100 parts by weight of the constituents 1 to 6 below:
1) 5 to 70 parts by weight of at least two (co)polymers belonging to at least two of the families i), ii) and iii),
2) 0 to 60 parts by weight of a water-immiscible solvent or mixture of solvents,
3) 0 to 30 parts by weight, of a water-miscible cosolvent or mixture of cosolvents, chosen from ketones, alcohols, glycols and polyglycol ethers,
4) 0.1 to 10 parts by weight of one or more ionic and/or nonionic surfactants and/or protective colloids and/or amphiphilic polymers,
5) 0 to 2, part by weight of one or more thickeners,
6) water (the sum of the constituents 1) to 6) representing 100 parts by weight).

4. A process for preparing the compositions as defined in claim 1, wherein:
either A1—a solution of polymers of at least two of the families i) to iii) in at least one water-immiscible organic solvent or mixture of solvents is prepared,
A2—one or more surfactants, pure or diluted in water or in another solvent (miscible or immiscible with water), are added to the solution obtained,
A3—water is added to form an emulsion,
A4—a water-miscible solvent or mixture of solvents is optionally added,
A5—one or more surfactants and/or one or more lacuna is optionally added, phases A1, A2, and A3 being performed with stirring, phase A4 possibly being performed at the same time or before phase A3, phase A5 possibly being performed at the same time as, before or after phase A4, the addition of water possibly being performed in either continuous, batch, semicontinuous or semibatch mode,
or Aa1—a solution of polymers of at least two of the families i) to iii) described above in at least one water-immiscible organic solvent or mixture of solvents is prepared,
Aa2—one or more surfactants, pure or diluted in water or in another solvent (miscible or immiscible with water), are added to the water,
Aa3—the polymer solution prepared in Aa1) is added to the water containing the surfactant(s) prepared in Aa2) to form an emulsion,
Aa4—a water-miscible solvent or mixture of solvents is optionally added,
Aa5—one or more surfactants and/or one or more thickeners are optionally added to improve the stability of the emulsion,
phases Aa1, Aa2, and Aa3 being performed with stirring, phase Aa4 possibly being performed at the same time as or before phase A3, and phase Aa5 possibly being performed at the same time as, before or after phase Aa4, the addition of water possibly being performed in either continuous, batch, semicontinuous or semibatch mode.

5. The process as claimed in claim 4, wherein:
either A1—a solution of 10 to 70 parts by weight of polymers of at least two of the families i) to iii) described above in 10 to 60 parts by weight of at least one water-immiscible organic solvent or mixture of solvents is prepared,
A2—0.1 to 10 parts by weight of pure or diluted surfactant(s) are added to the solution obtained,
A3—10 to 80 parts by weight of water are added to form an emulsion,
A4—0 to 30 parts by weight of a water-miscible solvent or mixture of solvents are added,
A5—0 to 3 parts by weight of one or more surfactants and/or 0 to 2 parts by weight of one or more thickeners are optionally added to improve the stability of the emulsion,
or Aa1—a solution of 10 to 70 parts by weight of polymers of at least two of the families i) to iii) described above in 10 to 60 parts by weight of at least one water-immiscible organic solvent or mixture of solvents is prepared,
Aa2—0.1 to 10 parts by weight of surfactant(s), pure or diluted in water or in another solvent (miscible or immiscible with water), are placed in 10 to 80 parts by weight of water,
Aa3—the polymer solution prepared in Aa1) is added to the water containing the surfactant(s) prepared in Aa2),
Aa4—0 to 30 parts by weight of a water-miscible solvent or mixture of solvents are optionally added,
Aa5—0 to 3 parts by weight of one or more surfactants and/or 0 to 2 parts by weight of one or more thickeners are optionally added.

6. The process as claimed in claim 4 for the preparation of compositions comprising at least a mixture of polymers i) and ii).

7. The process for preparing the compositions as defined in claim 1, wherein:
B1—at least two emulsions of polymers belonging solely to at least two of the three families i), ii) or iii) described above (each emulsion obtained thus contains solely polymers belonging to only one family i), ii), or iii)) according to process A or Aa, or, for the polymer emulsion derived from family iii), the process may also be performed by radical emulsion polymerization, performed conventionally in apparatus known for emulsion polymerizations according to a batch, semibatch, continuous or semicontinuous process, or for the emulsions of polymers i) not containing any water-immiscible solvent according to the well-known process of emulsification using an extruder,
B2—the polymer emulsions obtained in B1) are mixed together (by addition with stirring of one emulsion into the other at a temperature generally of at least 10° C., the temperature being chosen such that it is higher than the freezing point of the emulsions), it being understood that said emulsions to be mixed together must be derived from at least two of the families i), ii) and iii),
B3—one or more surfactants, and/or one or more thickeners are optionally added with stirring.

8. The composition as defined in claim 1 comprising an additive for lowering the pour point of crude oils and/or for inhibiting paraffin deposition in crude oils.

9. The composition of claim 1 wherein the n-alkyl (meth)acrylate monomers have an n of from 14 to 30.

10. The composition as claimed in claim 1, wherein the ethylenically unsaturated monomer is chosen from C₂ to C₅ vinyl esters, and vinyl acetate, C₁ to C₁₂ acrylates and methacrylates, and methyl, ethyl or propyl diesters of maleic acid, alkylmaleic acid, fumaric acid or alkylfumaric acid.

11. The composition as claimed in claim 3 comprising at least 100 parts by weight of the constituents 1 to 6 below:
1) 5 to 50 parts by weight of at least two (co)polymers belonging to at least two of the families i), ii) and iii),
2) 0 to 60 parts by weight of a water-immiscible solvent or mixture of solvents, chosen from aromatic solvents (toluene or xylene), alone or as a mixture,
3) from 5 to 25 parts by weight of a water-miscible cosolvent or mixture of cosolvents, chosen from ketones such as methyl ethyl ketone or methyl isobutyl ketone, alcohols such as butanol or isopropanol, glycols and polyglycol ethers such as ethylene or propylene glycol, and diethylene glycol or dipropylene glycol,
4) 0.1 to 8 parts by weight of one or more ionic and/or nonionic surfactants and/or protective colloids and/or amphiphilic polymers,
5) 0.01 to 0.6 part by weight of one or more thickeners,
6) water (the sum of the constituents 1) to 6) representing 100 parts by weight).

12. The composition as claimed in claim 1 wherein comprising at least 100 parts by weight of the constituents 1 to 6 below:
1) 5 to 40 parts by weight of at least two (co)polymers belonging to at least two of the families i), ii) and iii),
2) 0 to 60 parts by weight of a water-immiscible solvent or mixture of solvents,
3) 5 to 20 parts by weight of a water-miscible cosolvent or mixture of cosolvents, chosen from ketones, alcohols, glycols and polyglycol ethers,
4) 0.5 to 5 parts by weight of one or more ionic and/or nonionic surfactants and/or protective colloids and/or amphiphilic polymers,
5) 0.02 to 0.2 part by weight of one or more thickeners,
6) water (the sum of the constituents 1) to 6) representing 100 parts by weight).
